(19) United States
(12) Patent Application Publication
(10) Pub. No.: US 2014/0025195 A1
(43) Pub. Date: Jan. 23, 2014

(54) Computer Numerical Control Devices Employing Accelerometers And Associated Feedback Method

(71) Applicant: Farzad Ahmadpour, Naperville, IL (US)

(72) Inventor: Farzad Ahmadpour, Naperville, IL (US)

(21) Appl. No.: 13/936,062

(22) Filed: Jul. 5, 2013

Related U.S. Application Data
(60) Provisional application No. 61/668,409, filed on Jul. 5, 2012.

(51) Int. Cl. G05B 19/416

(52) U.S. Cl. CPC G05B 19/416
USPC 700/188

(57) ABSTRACT

A computer numerical control (CNC) device includes an integral accelerometer. A method of improving the accuracy CNC devices comprises integrating an accelerometer within the reader head of a linear feedback system. The feedback-system preferably incorporates acceleration feedback along with position feedback. The present CNC device can be incorporated in, and the method can be implemented for, machines including mills, lathes, routers, grinders, robotic devices, optical feedback systems, linear optical encodes, rotary optical encoders, servo drives and servo motors.

### CROSS-REFERENCE TO RELATED APPLICATION

This application is related to and claims priority benefits U.S. Provisional Patent Application Ser. No. 61/668,409 filed on Jul. 5, 2012, entitled “Computer Numerical Control Devices Employing Accelerometers And Associated Feedback Method”. The '409 provisional application is hereby incorporated by reference herein in its entirety.

### FIELD OF INVENTION

The present invention relates to computer numerical control (CNC) devices. In particular, the present invention relates to CNC devices incorporating accelerometers and an associated feedback technique for improving the precision of such devices. Such devices include CNC machine tools (mills, lathes, routers, grinders), robotic devices, optical feedback systems (linear and rotary optical encoders), as well as servo drives and servo motors.

### BACKGROUND OF THE INVENTION

Accelerometers are employed to measure and quantify the rigidity as well as the servo tuning status of machine tools, robotic devices, and precision control devices generally. Employing accelerometers in feedback control systems can also increase the stability of the axes in CNC devices, as well as their positioning accuracy. The use of accelerometers is also beneficial in monitoring and/or reducing vibrations during operation of a CNC device and in improving the accuracy of CNC device movements.

Micro-Electro-Mechanical Systems (MEMS) are based upon recent technologies that are widely used for various applications. MEMS were developed to be used as micro-sensors as well as micro-actuators. The main benefit of employing MEMS is their small size and economical cost. MEMS are small devices that can easily be integrated in a position feedback device to provide a 3-dimensional acceleration feedback as well as the angular gyroscopic characteristics of the device. Further background information on MEMS can be found at http://www.memsnet.org/mems/what_is.html.

MEMS accelerometers can be employed for the following purposes: (1) measuring rigidity on the guide-ways of the axes of CNC device, (2) testing circularity (ball-bar test), (3) integrating MEMS accelerometers into scales or encoders, and (4) evaluating vibration during the cutting of parts.

Rigidity Measurements

Rigidity of a CNC machine can be quantified by accelerometers, which identify mechanical problems on the axes of guide-ways. Unlike existing rigidity measuring equipment, the present accelerometer-based approach allows movement of the axis over longer distances that are sufficient to identify potential mechanical problems.

In conventional devices, a set of dial indicators on two sides of an axis is employed to test rigidity. This method is time consuming and somewhat impractical. Acoustic devices can also be used to measure vibration, but they are also inaccurate in locating the source of the vibration. Acoustic measurement only detects the quality of the guide-ways but provides no specific data about its rigidity.

The existing methods are limited for static tests when the machine is not actually operational and when the axes of the workpiece guide-ways are under force. Rigidity measurements must be done when the cutting force is applied and the guide-ways are under stress. The existing equipment for this purpose relies upon simple dial indicators. Sometimes it is difficult or impractical to use a dial indicator and watch them when the axes are moving or the spindle is operating.

MEMS accelerometers can be installed on virtually any location on the machine and can electronically report unexpected displacements on the axes or excessive vibration due to heavy cutting force which may not be suitable for the part or machine. Several accelerometers can be installed in several locations on the machine to report structural deviations, backlash or general rigidity problems.

The present micro-accelerometer approach evaluates the displacement of the guide-ways even in the presence of the cutting force to evaluate the rigidity of the guide-ways in 3-dimensions. With conventional methods, it may not be possible or very time-consuming to measure the rigidity of an axis guide-way. MEMS accelerators make it simple to do so.

Testing Circularity (Ball-Bar Test)

To identify servo-mismatch, backlash or other deflections on the axes of CNC devices, movements can be quantified using the present accelerometer-based technique. Existing methods offered by other companies employ 2-dimensional position sensors. Existing methods are time consuming, and have limited range of movement. In the micro-accelerometer based approach, there is no limit for the size of the movements. Existing equipment is also expensive, whereas employing MEMS accelerometers can reduce the cost dramatically. A MEMS accelerometer can perform measurements even when a CNC device is engaged in cutting a part, since the test process does not require stopping operation of the device.

Existing methods, although somewhat accurate, cannot be applied in the presence of cutting force or regular operation of a CNC machine. The existing methods include 2-dimensional optical encoders, linear transducers and laser interferometers. For each of these methods, the machine spindle must be stopped and it is not possible to cut into a part to measure the possible deviations in the presence of the cutting force. The other fundamental problem associated with these methods is the limitation of the displacement. For example, it is not possible to move the axes on a very large circle. In the transducer method, it is not possible to check a very small circle because the acceleration is much higher when the ball-bar test is on a small circle. When the circle is smaller, the amount of acceleration is higher and the possible deviations would be clearer. So it is preferred to have small circular movements to perform better measurements.

Renishaw (http://www.renishaw.com/en/test-theory-and-practice-6818) and others (see http://www.optodyne-usa.com/DownloadFile/lb500web.pdf) offer methods that employ linear transducer to report the radius of circular movements. These devices are limited in size and distance of movement, their setup time is extensive, and they are therefore expensive to install. Renishaw equipment cannot perform measurements for small circles. These conventional devices can only measure one degree of freedom. This fundamental limitation makes them impractical to report rigidity of a machine. Moreover, conventional devices are generally unable to perform the test under operating conditions.

Integrating Accelerometers Into Scales Or Encoders

Integrating micro-accelerometers into scales or encoders serves two purposes: (a) to provide acceleration feedback to increase stability and improve the bandwidth of the servo positioning, and (b) to provide information about vibration and possibly loss of accuracy due to unexpected displacement of the reader head. Incorporating a micro-accelerometer inside of the reader head of a linear feedback system enables the reporting of acceleration feedback into the CNC to increase its stability. It is also possible to monitor unexpected displacement of the reader head, which is a major cause of inaccuracy. Integrating accelerometers inside of a scale is an economical solution to provide an acceleration feedback to the CNC. This would allow implementing an acceleration observer loop to enhance the stability of an axis and ultimately enhance the machining surface quality.

Alignment is also a major problem in installing a linear scale. A misalignment can exacerbate inaccuracy.

In addition, MEMS accelerometers can be integrated inside of a regular linear encoder without increasing the size the reader head. This would have two benefits. First, it enables the controller to have another type of feedback from scale other than position, namely, acceleration feedback. Acceleration feedback can be incorporated into another feedback loop to enhance the response of the position CNC loop system. By applying acceleration feedback the system stability will be increased and it can monitor excessive vibration and stop the operation to ensure a better machining surface quality. The second benefit of integrating the MEMS accelerometers inside a scale is to detect and report unwanted sudden displacements of the reader head. These possible displacements could be critical for a scale's accuracy, especially in the case of exposed scales without protective cases that could align the reader head's movement on the scale, where unwanted displacements can dramatically reduce their accuracy.

Evaluating Vibration During The Part Cutting Process

Evaluation of the vibration during cutting part: Employing MEMS accelerometers are easier and less expensive than existing methods. Accelerometers can perform tests that conventional methods cannot. For example, the axes of a CNC device can be elongated by virtue of the ability of accelerometers to detect and report unwanted displacements. Moreover, accelerometer-based testing can be performed while a CNC device is in the process of cutting a part or to evaluate if the cutting condition is excessive for the machine or not. The other problem of using these devices is it cannot perform a measurement while the machine is cutting a part so it is not possible to measure when the machine is under operational conditions and in the presence of cutting force.

### SUMMARY OF THE INVENTION

A computer numerical control (CNC) device includes an integral accelerometer. The CNC device preferably resides on a printed circuit board. The accelerometer is preferably located within the reader head of a linear feedback system.

A method of improving the accuracy of computer numerical control (CNC) devices comprises integrating an accelerometer within the reader head of a linear feedback system. The feedback-system preferably incorporates acceleration feedback along with position feedback.

The present CNC device can be incorporated in, and the present accelerometer-based method can be implemented for, machines including mills, lathes, routers, grinders, robotic devices, optical feedback systems, linear optical encodes, rotary optical encoders, servo drives and servo motors.

### BRIEF DESCRIPTION OF THE DRAWINGS

FIG. 1 is a scanning electron microscopic image of a micro-accelerometer that can be employed in a computer numerical control (CNC) device.

FIG. 2 is a schematic image of an evaluation kit containing an LIS3LV02DL digital output low voltage linear accelerometer mounted on a printed circuit board.

FIG. 3 is a schematic diagram of one embodiment of a CNC milling machine with an accelerometer-based feedback control system.

FIG. 4 is a schematic diagram of another embodiment of a CNC milling machine with an accelerometer-based feedback control system.

FIG. 5 is a plot of acceleration as a function of time on a machine with low backlash and high rigidity. High speed creates low vibration. Curve A depicts the X-axis acceleration over time. Curve B depicts Y-Axis acceleration over time.

FIG. 6 is a plot of acceleration as a function of time on a machine with low backlash and high rigidity. Low speed creates high vibration. Curve C depicts the X-axis acceleration over time. Curve D depicts the Y-Axis acceleration over time.

FIG. 7 is a plot of acceleration as a function of time on a machine with large backlash and poor rigidity. Curve E depicts the X-axis acceleration over time. Curve F depicts the Y-Axis acceleration over time.

FIG. 8 is a flow diagram of a process for extracting wave characteristics from the output of an accelerometer.

FIG. 9 is a composite plot of acceleration as a function of time after applying a filter to extract the wave characteristics such as period and amplitude.

FIG. 10 is a plot of velocity along the X-axis versus velocity along the Y-axis to identify servo mismatch.

### DETAILED DESCRIPTION OF PREFERRED EMBODIMENT(S)

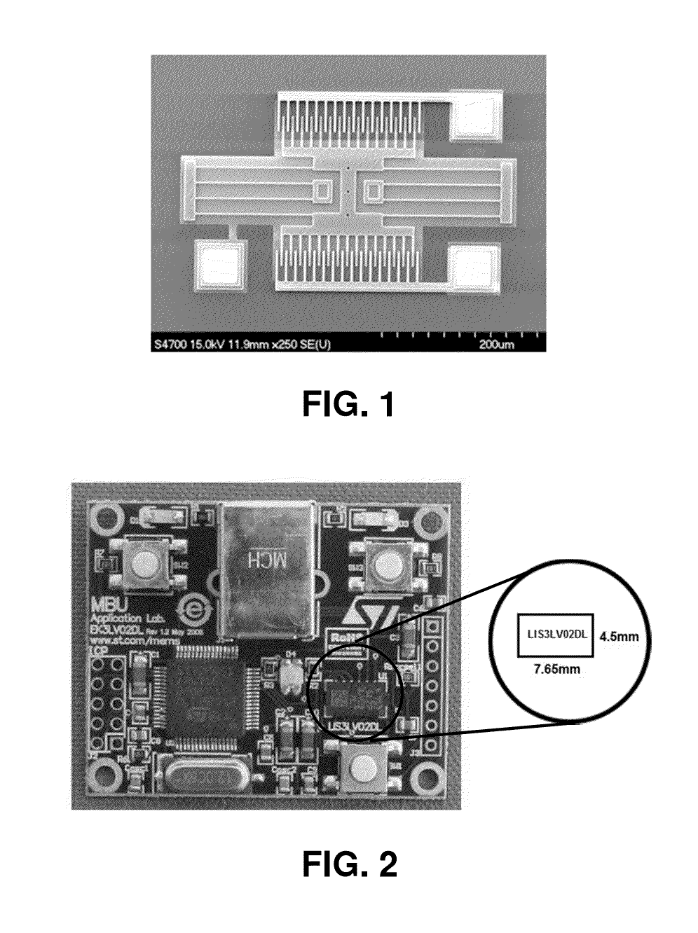

Turning first to FIGS. 1 and 2, an ST Electronics microchip LIS3LV02DL evaluation kit STEVAL-MKI005V1 MEMS 3-axis digital output low voltage linear accelerometer evaluation board of the type illustrated in FIG. 2 includes a micro-accelerometer of the type illustrated in FIG. 1. This device can measure 3-axes acceleration in range of ±2 g/±6 g with ±0.001 g resolution. The sampling frequency was either 40 Hz or 640 Hz in the examples. At slow speeds, the selected accelerometer is not particularly accurate, but it is effective at measuring and/or monitoring vibration.

The present micro-accelerometer based technique was conducted on two CNC machines: a CNC Vertical Machining Center (VMC) and a CNC Knee Mill. The VMC Machine was in good mechanical condition and the tests with the accelerometer showed the only problem was in its servo mismatch. The VMC machine also demonstrated good condition on guide-ways. The Knee Mill had large backlash on the X-axis ballscrew and its trust bearings and loose tapered gibs on Y Axis guide-ways.

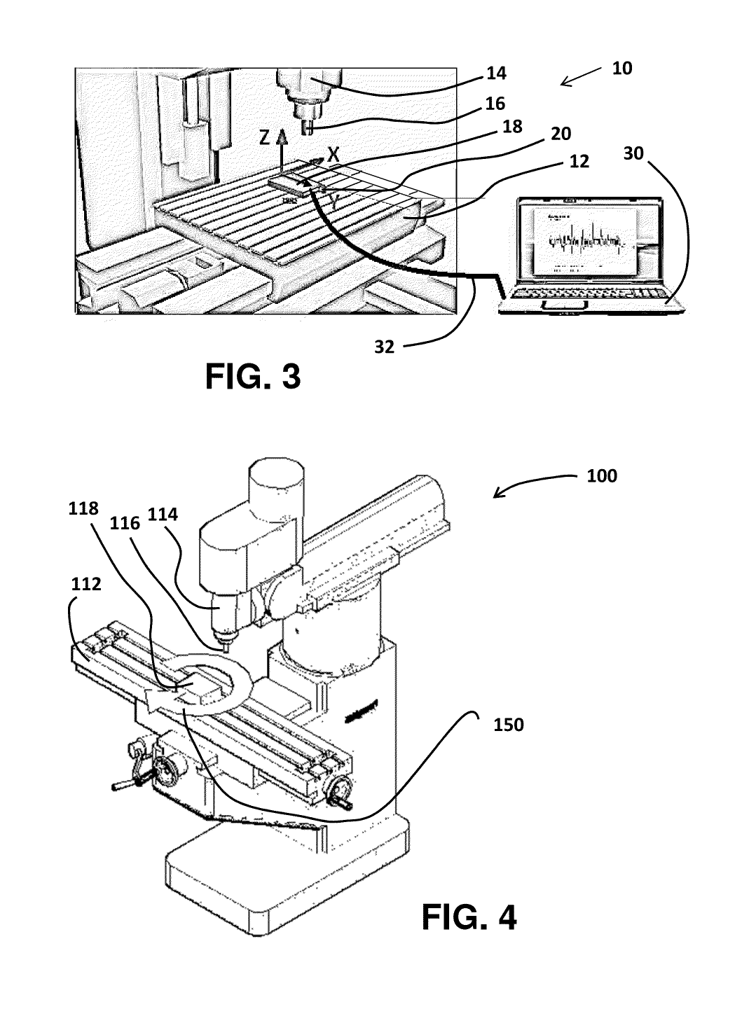

FIG. 3 illustrates one embodiment of a CNC milling machine 10 with an accelerometer-based feedback control system. CNC milling machine 10 includes a slidable table 12 on which workpiece 18 is mounted. CNC milling machine 10 also includes a cutting tool 16 extending from milling head 14. Accelerometer 20 is fastened to workpiece 18, with a cable 32 carrying acceleration data generated at workpiece 18 to a laptop computer 30.

In FIG. 4, another embodiment of a CNC milling machine 100 with an accelerometer-based feedback control system is illustrated. CNC milling machine 100 includes a slidable table 112 on which accelerometer 118 is mounted. CNC milling machine 100 also includes a milling head 114 from which a cutting tool 116 extends. Arrow 150 indicates the direction of circular motion of accelerometer 118.

Using the accelerometer-based feedback control system illustrated in FIG. 3, the procedure described herein took about 10 minutes to perform. The test procedure would have taken at least 1 hour with conventional Renishaw-type equipment. Using micro-accelerometers can improve the behavior of the closed loop positioning systems. The objective is to integrate the MEMS accelerometers inside of the reader head of a linear feedback and modify the feedback-CNC communication protocol to incorporate the acceleration feedback along with position feedback. The accelerometer loop was added in a computer modeled CNC in MATLAB. It is possible to lower the step function response time in the presence of large backlash and low rigidity. This would help to increase the performance of the CNC machine tools with low rigidity.

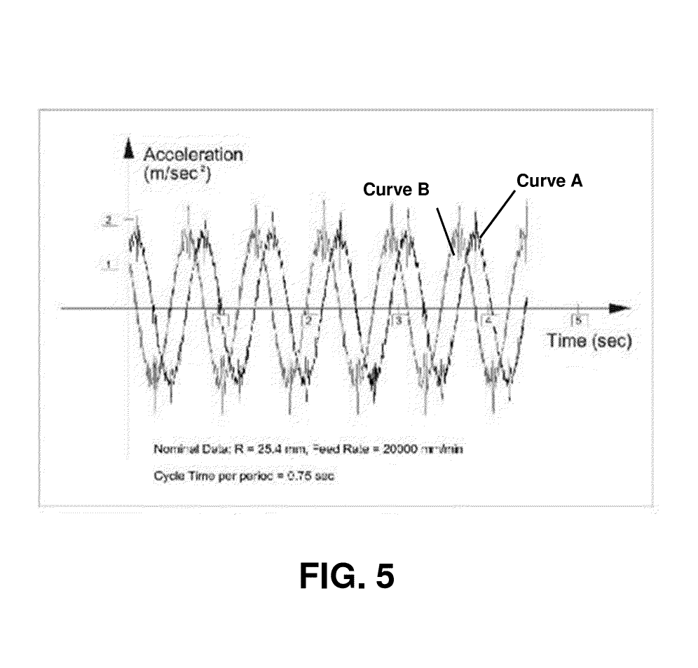

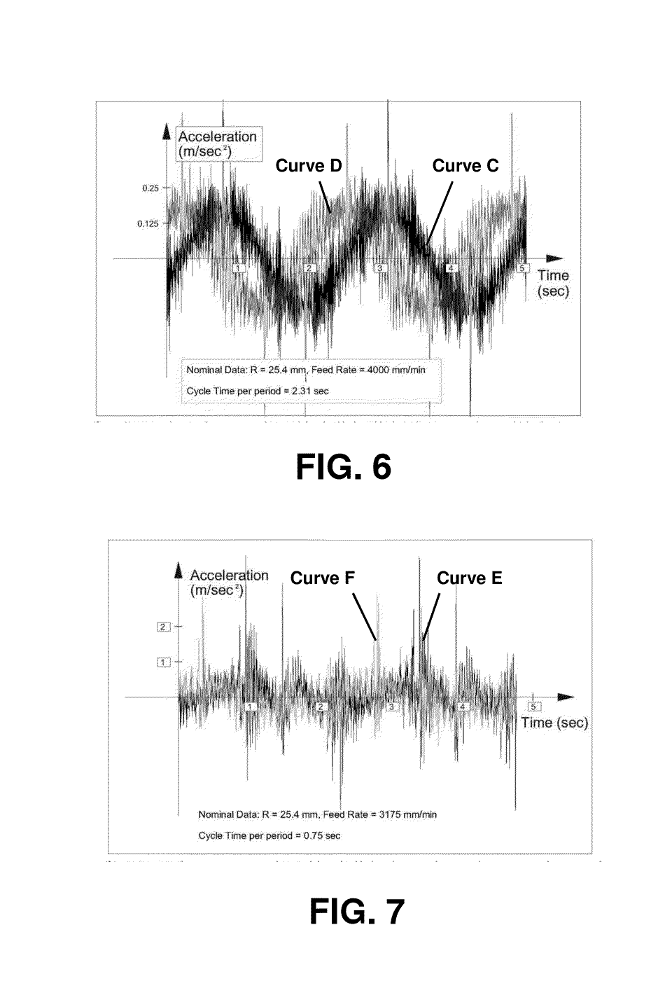

In these test procedures, the nominal programmed radius was 1 inch and the motion was continuous motion with look-ahead so it would not hesitate at the end of each circular move. By applying a look-ahead feature, the circular movement repeats in all quadrants were performed with the same nominal speed and acceleration. Acceleration data was measured in more than four turns and in several different speeds (feed rate). FIGS. 5, 6 and 7 are the acceleration curves over a period of time for circular interpolation on the two machines with high and low rigidity.

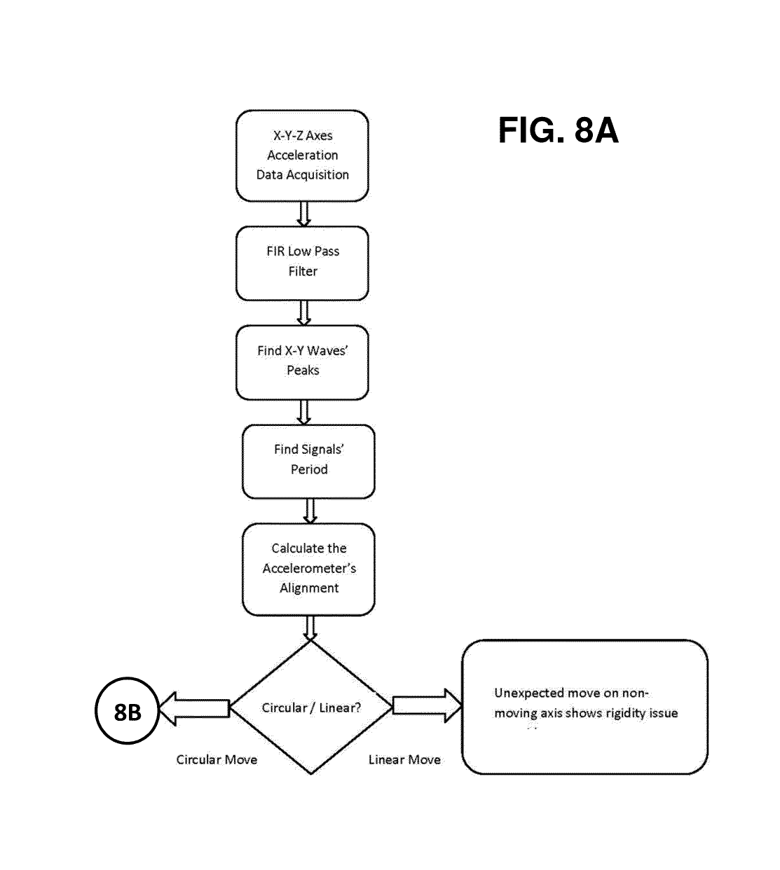

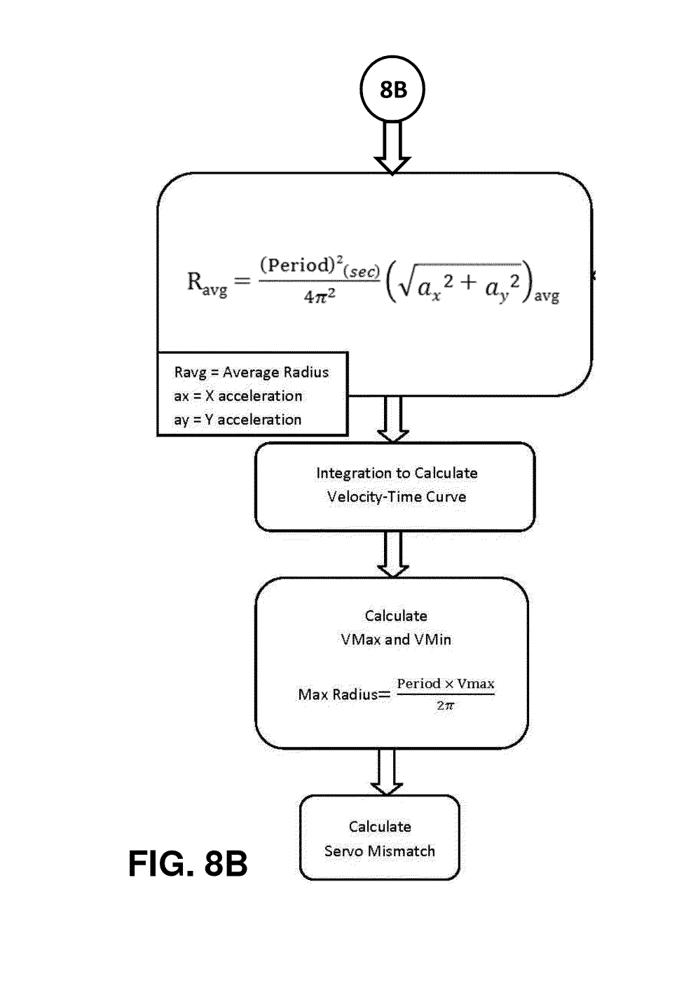

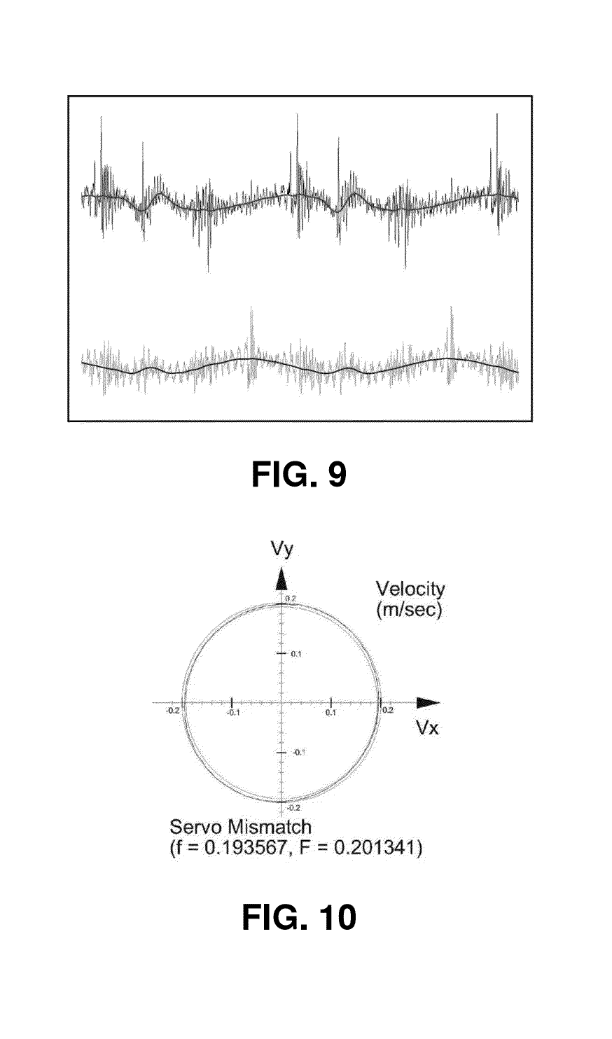

After applying a low frequency filter, as described in the algorithm set out in the flow chart of FIG. 8, it is possible to find wave's maximums and minimums and calculate its period based on a fixed sampling time. In this example, the sampling frequency was 640 Hz. FIG. 9 shows the curve fitted to the accelerometer data after applying the filter to extract the wave characteristics such as period and amplitude.

Circular Motion Characteristics

In a CNC machine it is possible to measure the servo mismatch for two axes that are moving on work pieces that are circular in cross-section. FIG. 10 is a plot of velocity along the X-axis versus velocity along the Y-axis, which identifies servo mismatch.

Existing methods offered by other companies employ 2-dimensional position sensors. The setting process is lengthy and it is limited in size. In the present accelerometer approach, there is no limit to the size of the movements. The present accelerometer approach can also generate 3-dimensional measurements that can be used for vibration analysis.

Vibration Analysis

When a linear movement is expected on an axis, the other axis should remain stationary. Unexpected vibrations or movements may have been present, however. This behavior can be monitored or measured by employing the present accelerometer-based approach. For example if a movement on X-axis shows vibration on Y-axis or Z-axis, a problem as to those movements is indicated.

Rigidity Analysis

When X axis moves, the acceleration data on Y-axis and Z-axis could show any possible displacements on the axes due to guide-ways problems (Rigidity Problems). With the present approach, this type of movement can be monitored by accelerometers that are placed in the farthest location from center of the guide-ways.

The following tables summarize benefits achievable by the present accelerometer-based approach in comparison to existing approaches:

TABLE 1
Benefits of Employing Accelerometers in a CNC Machine

| | CNC Machine | CNC Machine |
|---|---|---|
| | Performance Without | Performance With |
| Operational | Accelerometer | Accelerometer |
| Parameter | Feedback | Feedback |
| Vibration | Not enabled without | Accelerometer |
| Monitoring | accelerometer | feedback enables |
| | feedback. | excessive vibration to |
| | | be monitored. |
| Vibration | Enabled only through | Acceleration feedback |
| Control | servo loop adjustments | generates a higher |
| | by sacrificing higher | bandwidth and enables |
| | speeds. | a machine structure to |
| | | eventually reach its |
| | | maximum attainable |
| | | speed. |
| Positioning | Enabled only through | Positioning can be |
| Accuracy | servo loop adjustments | done much faster with |
| | by sacrificing higher | minimal overshoot. |
| | speeds. | |
| Contour | To move along a | Position, Velocity and |
| Accuracy | contour accurately, | Acceleration all have |
| | Position, Velocity and | true feedback, thereby |
| | Acceleration | increasing the accuracy |
| | commands are sent to | of contours and |
| | the CNC. Without | enabling faster cutting. |
| | accelerometer | |
| | feedback, only Position | |
| | and Velocity involve | |
| | true feedback; | |
| | Acceleration is only an | |
| | extrapolation of motor | |
| | current. | |
| CNC Body | Not enabled without | Several accelerometers |
| Deflection | accelerometer | can be installed on |
| Monitoring | feedback. | critical points of the |
| | | machine. The device |
| | | can map a three- |
| | | dimensional deflection |
| | | and report it in |
| | | different |
| | | circumstances. |

TABLE 2
MEMS Accelerometer vs. Mechanical Accelerometer

| | Mechanical | MEMS |
|---|---|---|
| Characteristic | Accelerometer | Accelerometer |
| Size | Large and Bulky. | Very small. |
| Price | Expensive. | Very inexpensive. |
| Utility | Limited to large | By virtue of its very |
| | structures such as | small size, can be |
| | airplanes and dams. | installed in virtually |
| | | any structure, including |
| | | linear position |
| | | feedback systems. |
| Response Time | Slow. | Very fast. |
| due to internal | | |
| mass | | |
| Accuracy for low | High = almost 0.1 mg. | Low = almost 1 mg. |
| acceleration | | |

TABLE 3
Ball-bar Test Equipment: Optical vs. MEMS

| Operational | Optical Ball-Bar | |
|---|---|---|
| Parameter | Test | MEMS Ball-Bar Test |
| Circle Size | Limited. | Virtually unlimited. |
| Setup Time | Large and laborious. | Very low; only |
| | | involves running |
| | | computer software. |
| Utility | None during Spindle | Virtually unlimited. |
| | Move or during | |
| | machine operation. | |
| Non-Circular | Limited to circular | Profiles measurable |
| Profile Checks, | test. | are virtually |
| such as | | unlimited. |
| rectangular and | | |
| irregular paths | | |
| Price | Expensive. | Inexpensive (software |
| | | costs only). |

The present accelerometer-based approach provides the actual mechanical stress feedback from cutting forces or other causes that lead to vibration. By utilizing this feedback, the CNC operates with minimum vibration and maximum surface quality. The present acceleration feedback device can be integrated within the scale reader head and provides real-time acceleration feedback for the CNC to reduce speed in the presence of high vibration. In long term, mechanical vibration will be reduced dramatically and the longevity of mechanical parts will be increased.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A computer numerical control (CNC) device comprising an integral accelerometer.

2. The CNC device of claim 1 wherein the device resides on a printed circuit board.

3. The CNC device of claim 1 wherein the accelerometer is within a reader head of a linear feedback system.

4. The CNC device of claim 1 wherein the device is incorporated in machines selected from the group consisting of mills, lathes, routers, grinders, robotic devices, optical feedback systems, linear optical encodes, rotary optical encoders, servo drives and servo motors.

5. A method of improving the accuracy of computer numerical control (CNC) devices comprising integrating an accelerometer within a reader head of a linear feedback system.

6. The method of claim 5 wherein the feedback-system incorporates acceleration feedback along with position feedback.

7. The method of claim 5 wherein the method is implemented for machines selected from the group consisting of mills, lathes, routers, grinders, robotic devices, optical feedback systems, linear optical encodes, rotary optical encoders, servo drives and servo motors.
